(19) United States
(12) Patent Application Publication
(10) Pub. No.: US 2010/0252572 A1
(43) Pub. Date: Oct. 7, 2010

(54) Flexible fuel tank carrier and method of dispensing fuel

(76) Inventor: Stephan Sendelbach, Loves Park, IL (US)

Correspondence Address: RYAN KROMHOLZ & MANION, S.C., POST OFFICE BOX 26618, MILWAUKEE, WI, 53226, US

(21) Appl. No.: 11/654,048

(22) Filed: Jan. 17, 2007

Related U.S. Application Data
(60) Provisional application No. 60/761,949, filed on Jan. 25, 2006.

(51) Int. Cl. B65D 35/56; B67D 7/06; A47G 19/14

(52) U.S. Cl. 222/105; 222/183; 222/465.1

(57) ABSTRACT

The disclosed carrier is a semi-rigid, semi-flexible apparatus with convenient handles, support structure, anchoring mechanisms, access ports and reinforced bases. The carrier assists in containing otherwise highly compliant walls of a flexible tank contained therein.

### RELATED APPLICATION

This application claims the benefit of U.S. Provisional Application Ser. No. 60/761,949, filed Jan. 25, 2006.

### BACKGROUND OF THE INVENTION

This invention relates to an apparatus and methods for carrying flexible fuel tanks. Flexible fuel tanks are generally a synthetic, fuel-resistant type of fuel tank made of rubber, canvas, nylon or other suitable materials.

Flexible fuel tanks, such as that disclosed in U.S. Pat. No. 5,913,451, which is incorporated herein by reference, are used to store fuels, such as gasoline, for use by vehicles, aircraft and watercraft.

Flexible fuel tanks are becoming particularly more popular due to their ability to reduce emissions, handle blended fuel mixtures, and thereby increase gasoline consumption efficiency. Particularly, advance of flexible fuel tank construction deters the formation of fuel vapor, thereby avoiding the problems associated with dealing with fuel vapor. Because the fuel vapor is never allowed to form in void spaces as in traditional fuel storage systems, there is decreased emission and reduced risk of excess pressure build-up in the void spaces.

In the commercial embodiment of U.S. Pat. No. 5,913,451, a rigid outer shell contains a flexible double-walled flexible bladder. Hydraulic fluid, or charge fluid, fills the space between the walls, allowing the flexible bladder to conform to the amount of fuel it receives. As fuel is used, the bladder contracts to eliminate any void space that would otherwise occur by the withdrawal of fuel.

Flexible fuel tank liners can be installed to reduce the risk of fuel leak following damage, and in airline settings, the possibility of a shock wave that could induce fuel instability and fuel tank rupture.

However, flexible fuel tanks are rather difficult to transport due to their floppy and unwieldy nature. The present invention is directed toward solving the transportability of flexible fuel tanks by providing a carrier for flexible fuel tanks.

### SUMMARY OF THE INVENTION

A carrier for a flexible fuel tank and a method of dispensing fuel is disclosed.

The carrier comprises a semi-rigid, semi-flexible apparatus with convenient handles, support structure, anchoring mechanisms, access ports and reinforced bases. The carrier assists in containing otherwise highly compliant walls of the flexible tank contained therein.

### BRIEF DESCRIPTION OF THE DRAWINGS

FIG. 1 is a top view of a carrier of the present invention.

FIG. 2 is a side view of a carrier of the present invention.

FIG. 3 is another side view of a carrier of the present invention.

FIG. 4 is a perspective exploded view of an alternative embodiment of a carrier of the present invention.

FIG. 5 is a top view of an alternative embodiment of a carrier of the present invention.

FIG. 6 is a side view of an alternative embodiment of a carrier of the present invention.

FIG. 7 is a side view of an alternative embodiment of a carrier of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Referring now to FIG. 1, a carrier 10 of the present invention is shown. In this embodiment, the carrier 10 comprises handles 12 that are preferably one-piece, and suitable for carrying the weight of fuel intended in the flexible fuel container (not shown) intended to be placed at least partially within the carrier 10. Access ports 16 are provided in a user preferred configuration. The handles 12 are formed of a preferably one-piece material, the ends of which overlap and attach at the top handle 30, which preferably conceals the seam at the ends of the overlap (not shown) and also provides a means for keeping the two adjacent handles 12 together if desired, either by including a snap or hook and loop material at the top handle 30.

The preferred materials for forming the carrier 10 comprise coated shell textile having a DWR coating on the outside and a heavy polyurethane coating on the inside. DWR is a fabric treatment which stands for Durable, Water, Resistant. This durable water resistant treatment coats the fibers of the fabric with a hydrophobic finish, that causes liquid to bead up and roll off of the fabric.

Ports 16 are preferably sewn bonded as shown for reinforcement and to provide robust and long lasting effects to the carrier 10. Additionally, a polyurethane coating can be applied to the bindings for robustness. Double stitching is preferred, as is the use of a strong threat material, such as Kevlar® thread.

Ports 16 are preferably configured for retention and/or pass through any combination of hoses, nozzles, and filling and dispensing lines that attach to the flexible tank itself.

Ports 16 may also provide access to charge liquid lines of the flexible tank itself, or ports 16 may also comprise carrying pockets or access points for items such as user directions and warning symbols.

A flap 20 is provided with embedded grommets 22, and like flaps 20 may be incorporated about a periphery of a wall 14 to provide for mounting points to secure the tank 10 as desired. A plurality of walls 14 define the upper, lower, and four (more or less) side walls of the carrier 10. Walls 14 can be lined with foam and sheet plastic for padding in a preferred embodiment for further reinforcement.

The walls 14 and flaps 20 are preferably reinforced with sheet plastic for rigidity and durability. It is understood that the carrier 10 need not be cubic as shown, but can incorporate any shape desired in accordance with the shape of the received flexible fuel container.

A zipper 18 or like access material (hook and loop, etc) is provided about the periphery of the top wall 14, so that the carrier 10 may be opened and the flexible tank inserted thereto.

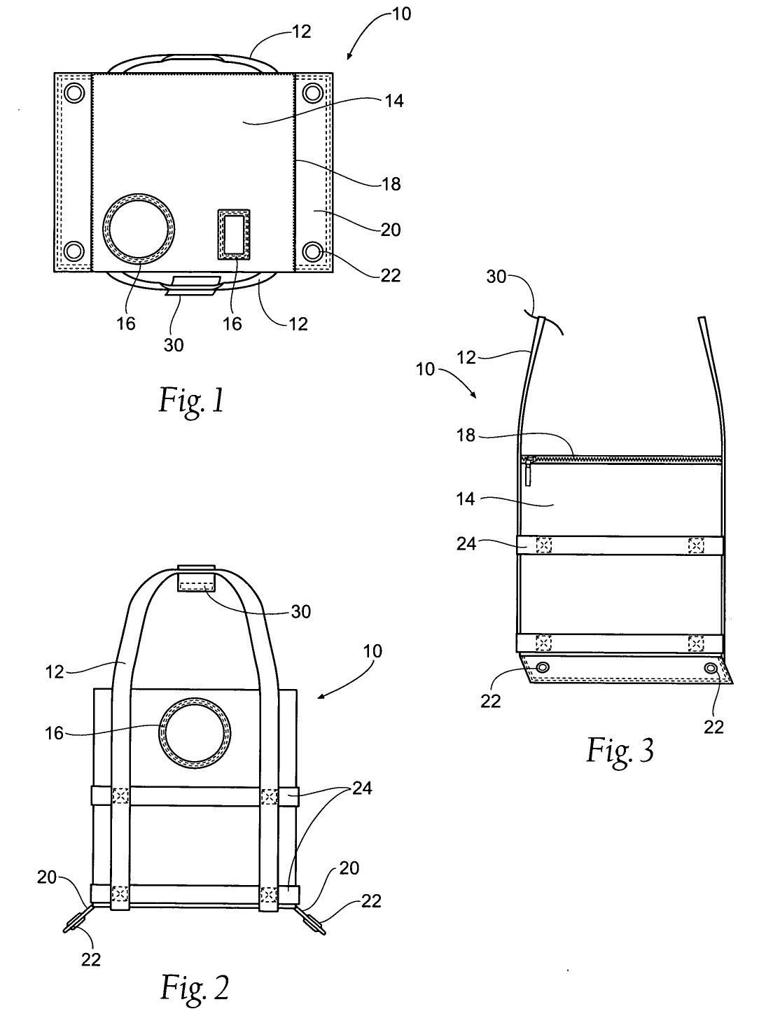

Referring now to FIGS. 2 and 3, a side view of the carrier 10 is shown. In these views, additional ports 16 are provided, and support structure 24 is shown. In one embodiment, support structure 24 comprises webbing similar to that of the handles 12, although in additional embodiments, more rigid support such as struts or bars could be provided either vertically or horizontally in accordance with end-user preference.

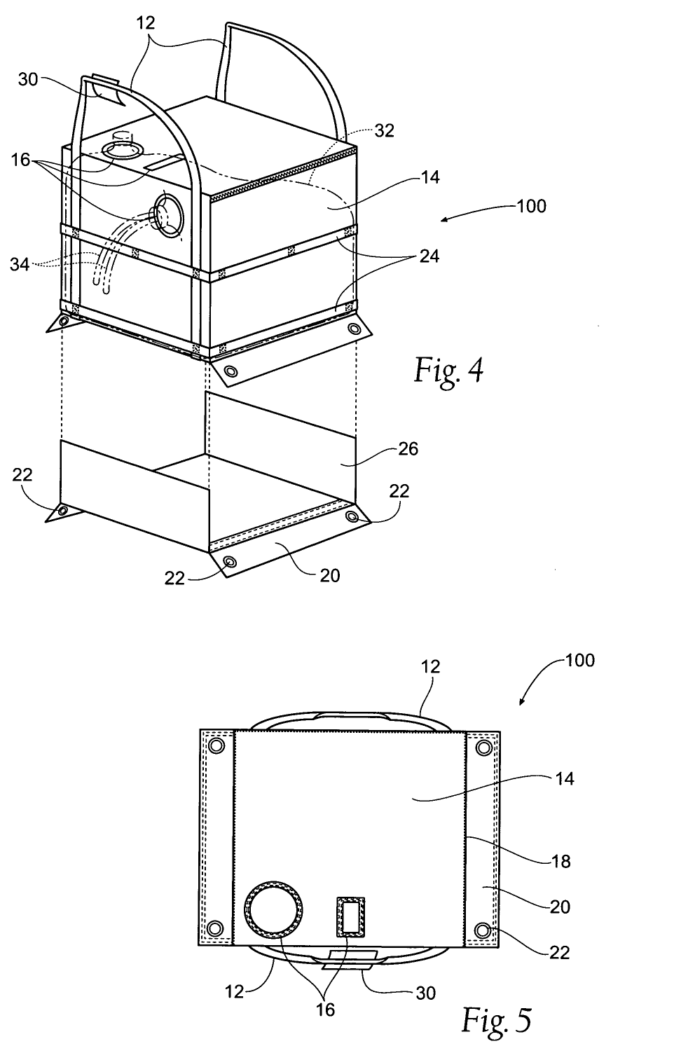

Referring now to FIG. 4, the carrier 10 is shown carrying flexible fuel tank 32 and associated lines 34, which may comprise any combination of hoses, nozzles, and filling and dispensing lines 34 that attach to the flexible tank itself. In this manner, lines 34 can be readily passed through carrier 10 to their respective connections on the tank 32 and external of the carrier 10.

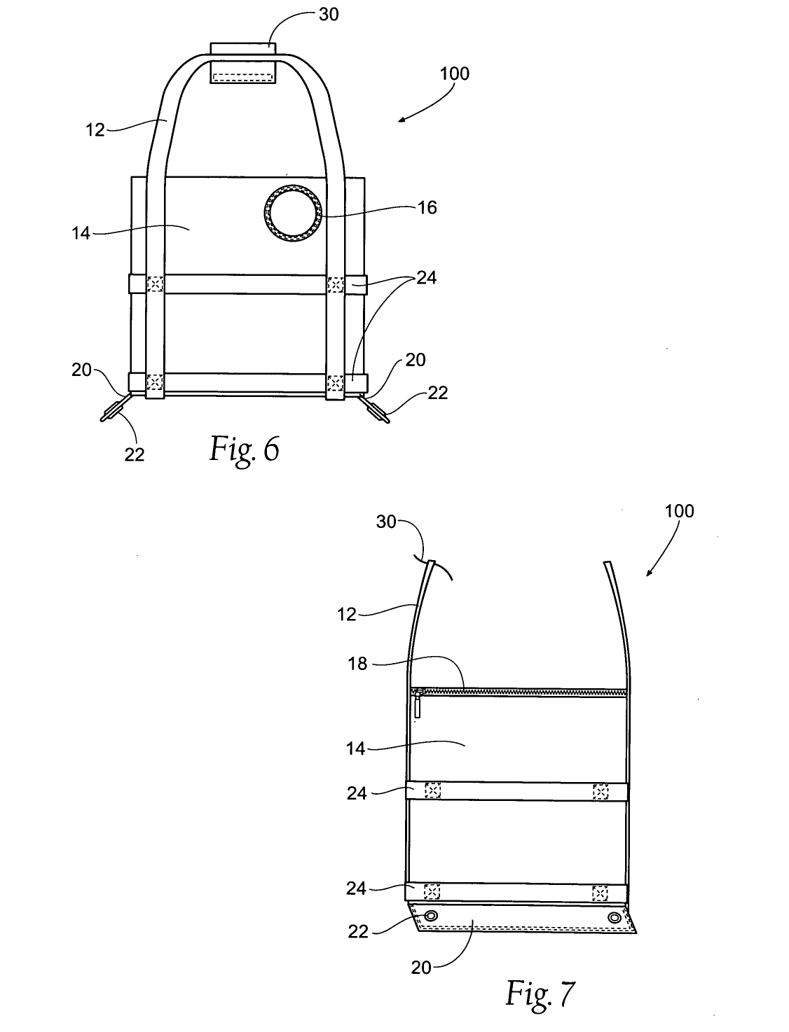

Referring now to FIGS. 4-7, a perspective exploded view of an alternative embodiment of a carrier 100 of the present invention is shown. In this embodiment, a bottom panel 26 has been added to the walls 14 to provide for reinforcement of the carrier 10. The bottom panel 26 can comprise a different material than the walls 14 if desired. Preferably, the bottom panel 26 is coupled to the walls 14 of the container by seams concealed by support structure 24 to add to the aesthetics of the carrier 10. Alternatively, the bottom panel is removably coupled with bottom wall 14, as shown in the exploded view of FIG. 4.

In alternative embodiments (not shown), some of the elements of the flexible tank itself may be incorporated or coupled with the carriers 10 and 100. For instance, ports 16 could comprise tubular shaped lines intended for retention and/or pass through any combination of hoses, nozzles, and filling and dispensing lines.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An apparatus for dispensing fuel comprising:
a flexible fuel tank;
a plurality of side walls;
a top wall;
a first bottom wall;
a flap coupled to said bottom wall, said flap comprising at least one grommet for securing said flexible fuel tank carrier;
a handle coupled to at least one side wall, said handle extending over said side wall for grasping said flexible fuel tank carrier;
a first void space provided on said top wall;
a second void space provided on said bottom wall;
a third void space provided on at least one of said side walls;
said top wall selectively partially coupled to at least one of said side walls;
said side walls, said top and said bottom wall configured to receive a flexible fuel tank;
said first, second and third void spaces configured to receive at least one of a hose, nozzle, filling, and dispensing lines coupled to said flexible fuel tank.

2. An apparatus for dispensing fuel according to claim 1, the apparatus further comprising:
a second bottom wall coupled with said bottom wall.

3. An apparatus for dispensing fuel according to claim 1, wherein said walls are foam reinforced.
